(19) United States
(12) Patent Application Publication
(10) Pub. No.: US 2017/0318483 A1
(43) Pub. Date: Nov. 2, 2017

(54) SELF-RECOVERY METHOD AND DEVICE AFTER DISCONNECTION OF BASE STATION

(71) Applicant: ZTE CORPORATION, Shenzhen City (CN)

(72) Inventor: Dunhua ZHANG, Shenzhen City (CN)

(73) Assignee: ZTE CORPORATION, Shenzhen City (CN)

(21) Appl. No.: 15/522,184

(22) PCT Filed: Apr. 14, 2015
(86) PCT No.: PCT/CN2015/076549

§ 371 Date: Apr. 26, 2017

(30) Foreign Application Priority Data
Oct. 28, 2014 (CN) 201410589122.9

(51) Int. Cl. H04W 24/04; H04W 8/22

(52) U.S. Cl. CPC H04W 24/04; H04W 8/22

(57) ABSTRACT

A self-recovery method and device after disconnection of a base station are described. The method includes: when a base station cannot connect with a network management system through a link, the base station detects a cumulative time length for link interruption; when the cumulative time length for link interruption exceeds a designated time length, the base station sends a request for acquiring an IP address to the network management system through an underlying communication protocol, the request carries a unique identification of the base station; the base station establishes an IP link with the network management system according to the IP address returned by the network management system; and the base station loads base station software and configuration data according to information acquired from the network management system.

### CROSS-REFERENCE TO RELATED APPLICATION

This application is the U.S. national phase of PCT Application No. PCT/CN2015/076549 filed Apr. 14, 2015, which claims priority to Chinese Application No. 201410589122.9 filed Oct. 28, 2014, the disclosures of which are incorporated in their entirety by reference herein.

### TECHNICAL FIELD

The document relates to the technical field of self-recovery after disconnection of a base station, in particular to a self-recovery method and device after disconnection of a base station.

### BACKGROUND

With the unceasing development and evolution of wireless networks, a great number of wireless base station systems are deployed in all places around the world, and the maintenance management of base stations is important and complex work. Usually, the maintenance work of a base station is completed in a central telecommunications room. When the base station operates normally, the base station communicates with a network management system of the central telecommunications room through a transmission link, and a user can perform remote operation and maintenance management for the base station on the network management system. However, when disconnection of the base station is caused and the base station cannot communicate with the network management system since some abnormal situations occur, operation and maintenance personnel have to go to the base station to perform maintenance processing on a network element. As a result, a great amount of labor and time are consumed.

Causes of the disconnection of the base station are many and mainly include the following causes:

(1) Communication is interrupted due to failure of a transmission link.

(2) Base station hardware devices are damaged.

(3) The base station downloads incorrect software releases, or base station software itself has a bug, and disconnection of the base station is caused after the base station software is operated.

(4) The base station activates incorrect configuration data, and disconnection of the base station is caused after operation (e.g., IP address configuration is incorrect).

In the above-mentioned causes, the problem (1) can be solved after the transmission link is repaired, and the problem (2) can be solved after personnel go to the base station to replace the damaged hardware, and these two problems are not in the range to be processed by the present disclosure. The problems (3) and (4) are common and main causes of the disconnection of the base station, and frequently the disconnection of the base station is caused due to a mistake of maintenance personnel or a bug of the software itself.

### SUMMARY

The technical problem to be solved by the present disclosure is how a base station automatically performs system recovery and is connected to a network management system to avoid the situation that personnel need to go to the base station to perform processing when disconnection of the base station is caused due to the abnormality of base station software or configuration data, therefore the maintenance efficiency is improved and the consumption of labor and time is reduced.

To solve the above-mentioned problem, the following technical solution is adopted.

A self-recovery method after disconnection of a base station, applied to a base station side, includes:

when a base station cannot connect with a network management system through a link, the base station detects a cumulative time length for link interruption;

when the cumulative time length for link interruption exceeds a designated time length, the base station sends a request for acquiring an Internet Protocol (IP) address to the network management system through an underlying communication protocol, herein the request carries a unique identification of the base station;

the base station establishes an IP link with the network management system according to the IP address returned by the network management system; and

the base station loads base station software and configuration data according to information acquired from the network management system.

In an exemplary embodiment, the step that the base station loads base station software and configuration data according to information acquired from the network management system includes:

the base station sends a request for acquiring the base station software and configuration data to the network management system;

the base station receives the base station software and configuration data returned by the network management system; and

the base station loads the base station software and configuration data.

In an exemplary embodiment, the step that the base station sends a request for acquiring an IP address to the network management system through an underlying communication protocol includes: the base station carries error information in the request; and

the step that the base station loads base station software and configuration data according to information acquired from the network management system includes: the base station receives a patch pack returned by the network management system, herein the patch pack includes correction information for base station software and configuration data; and the base station reloads the base station software and configuration data according to the correction information.

A self-recovery method after disconnection of a base station, applied to a network management system side, includes:

the network management system receives a request for acquiring an Internet Protocol (IP) address sent by a base station through an underlying communication protocol, herein the request carries a unique identification of the base station;

after receiving the request for acquiring the IP address, the network management system searches for the IP address corresponding to the unique identification in base station information which is saved in advance, and returns the searched IP address to the base station;

the network management system establishes an IP link with the base station according to the IP address; and

the network management system sends base station software and configuration data for information loading to the base station according to the request of the base station.

In an exemplary embodiment, the step that the network management system sends base station software and configuration data for information loading to the base station according to the request of the base station includes:

the network management system receives a request for acquiring the base station software and configuration data sent by the base station; and

the network management system searches for the base station software and configuration data of the base station in the base station information which is saved in advance, and returns the searched base station software and configuration data to the base station.

In an exemplary embodiment, the request for acquiring the IP address further carries error information; and the step that the network management system sends base station software and configuration data for information loading to the base station according to the request of the base station includes:

the network management system generates a patch pack according to the error information and returns the patch pack to the base station, herein the patch pack includes correction information for base station software and configuration data such that the base station reloads the base station software and configuration data according to the correction information.

A self-recovery device after disconnection of a base station, arranged in a base station, includes a link interruption detection module and a self-recovery module.

The link interruption detection module is configured to, when the base station cannot connect with a network management system through a link, detect a cumulative time length for link interruption.

The self-recovery module is configured to, when the cumulative time length for link interruption detected by the link interruption detection module exceeds a designated time length, send a request for acquiring an IP address to the network management system through an underlying communication protocol, herein the request carries a unique identification of the base station; establish an IP link with the network management system according to the IP address returned by the network management system; and load base station software and configuration data according to information acquired from the network management system.

In an exemplary embodiment, the self-recovery module is configured to load base station software and configuration data according to information acquired from the network management system by the following mode.

The self-recovery module sends a request for acquiring the base station software and configuration data to the network management system; receiving the base station software and configuration data returned by the network management system; and loading the base station software and configuration data.

In an exemplary embodiment, the request for acquiring the IP address sent by the self-recovery module to the network management system further carries error information; and the self-recovery module is configured to load base station software and configuration data according to information acquired from the network management system by the following mode: the self-recovery module receiving a patch pack returned by the network management system, herein the patch pack includes correction information for the base station software and configuration data; and reloading the base station software and configuration data according to the correction information.

A self-recovery device after disconnection of a base station, arranged at a network management system side, includes a self-recovery service module and a base station information table saving module.

The self-recovery service module is configured to, when receiving a request for acquiring an IP address sent by a base station through an underlying communication protocol, search for the IP address, corresponding to a unique identification of the base station in the request, in base station information which is saved in advance, and return the searched IP address to the base station; establish an IP link with the base station according to the IP address; and send base station software and configuration data for information loading to the base station according to the request of the base station.

The base station information table saving module is configured to save the IP address of the base station, the base station software and configuration data for information loading and a patch pack.

In an exemplary embodiment, the self-recovery service module is configured to send base station software and configuration data for information loading to the base station according to the request of the base station by the following mode.

The self-recovery service module receiving a request for acquiring base station software and configuration data sent by the base station, and then searching for the base station software and configuration data of the base station in the base station information which is saved in advance, and returning the searched base station software and configuration data to the base station.

In an exemplary embodiment, the request for acquiring the IP address further carries error information; and the self-recovery service module is further configured to, after the IP link is established, generate a patch pack according to the error information and return the patch pack to the base station, herein the patch pack includes correction information for the base station software and configuration data such that the base station reloads the base station software and configuration data according to the correction information.

A computer program including program instructions is provided. Herein, when program instructions are executed by a base station, the base station can execute the self-recovery method after disconnection of the base station applied to the base station side.

A carrier carries the computer program.

A computer program including program instructions is provided. Herein, when program instructions are executed by a network management system, the network management system can execute the self-recovery method after disconnection of the base station applied to the network management system side.

A carrier carries the computer program.

Aiming at the problem that a great amount of labor and time are wasted and consumed since personnel have to go to a base station for recovery at present when disconnection of the base station is caused and the base station cannot communicate with a network management system due to incorrectly issuing of the base station software release or configuration data in related base station management, the present disclosure provides a new solution. By using the technical solution provided by the present disclosure, the system can automatically solve the problem of disconnection of the base station which is caused due to the abnormality of the base station software or configuration data. In the existing art, personnel need to go to the base station, and consequently a great amount of labor and time are consumed. By using the technical solution provided by the present disclosure, the problem is avoided and the system availability is improved.

### BRIEF DESCRIPTION OF DRAWINGS

FIG. 1 illustrates a schematic diagram of a self-recovery device after disconnection of a base station according to one embodiment of the present disclosure.

FIG. 2 illustrates a flowchart of operation at a base station side according to one embodiment of the present disclosure.

FIG. 3 illustrates a flowchart of operation at a network management system side according to one embodiment of the present disclosure.

### DETAILED DESCRIPTION

The technical solution of the present disclosure will be described below in more detail with reference to the drawings in combination with the embodiments.

It needs to be stated that the embodiments of the present disclosure and the features in the embodiments may be mutually combined under the situation of no conflict within the protection scope of the present disclosure. In addition, although logic sequences are illustrated in flowcharts, under certain circumstances, the illustrated or described steps may be executed according to sequences different from the sequences here.

A self-recovery method after disconnection of a base station includes:

when a base station cannot connect with a network management system through a link, the base station detects a cumulative time length for link interruption;

when the cumulative time length for link interruption exceeds a designated time length, the base station sends a request for acquiring an IP address to the network management system through an underlying communication protocol, herein the request carries a unique identification of the base station; the base station establishes an IP link with the network management system according to the IP address returned by the network management system; and the base station loads base station software and configuration data according to information acquired from the network management system.

After the loading is completed, if the base station is successfully started, the base station may successfully establish a maintenance link with the network management system.

In an exemplary embodiment, the step that the base station loads base station software and configuration data according to information acquired from the network management system specifically may include:

the base station sends a request for acquiring base station software and configuration data to the network management system;

the base station receives the base station software and configuration data returned by the network management system; and

the base station loads the base station software and configuration data.

In an exemplary embodiment, error information is further carried when the base station sends the request for acquiring the IP address to the network management system.

The step that the base station loads base station software and configuration data according to information acquired from the network management system specifically may include:

the base station receives a patch pack returned by the network management system, herein the patch pack includes correction information for base station software and configuration data;

and the base station reloads the base station software and configuration data according to the correction information.

A self-recovery method after disconnection of a base station includes the following steps.

When a base station cannot connect with a network management system through a link, the base station detects a cumulative time length for link interruption.

When the cumulative time length for link interruption exceeds a designated time length, the base station sends a request for acquiring an IP address to the network management system through an underlying communication protocol, herein the request carries a unique identification of the base station.

After receiving the request for acquiring the IP address, the network management system searches for the IP address corresponding to the unique identification in base station information which is saved in advance, and returns the IP address to the base station.

The base station establishes an IP link with the network management system according to the IP address returned by the network management system; and loads base station software and configuration data according to information acquired from the network management system.

After the loading is completed, if the base station is successfully started, the base station may successfully establish a maintenance link with the network management system.

In an exemplary embodiment, the step that the base station loads base station software and configuration data according to information acquired from the network management system specifically includes:

the base station sends a request for acquiring base station software and configuration data to the network management system;

after receiving the request for acquiring the base station software and configuration data, the network management system searches for the base station software and configuration data of the base station in base station information which is saved in advance, and returns the base station software and configuration data to the base station;

the base station receives the base station software and configuration data returned by the network management system; and

the base station loads the base station software and configuration data.

In an exemplary embodiment, error information is further carried when the base station sends the request for acquiring the IP address to the network management system; and

the step that the base station loads base station software and configuration data according to information acquired from the network management system specifically includes:

after the IP link is established, the network management system generates a patch pack according to the error information and returns the patch pack to the base station, herein the patch pack includes correction information for base station software and configuration data;

the base station receives the patch pack returned by the network management system; and

the base station reloads the base station software and configuration data according to the correction information.

A self-recovery device after disconnection of a base station, arranged in a base station, includes a link interruption detection module and a self-recovery module.

The link interruption detection module is configured to, when the base station cannot connect with a network management system through a link, detect a cumulative time length for link interruption.

The self-recovery module is configured to, when the cumulative time length for link interruption detected by the link interruption detection module exceeds a designated time length, send a request for acquiring an IP address to the network management system through an underlying communication protocol, herein the request carries a unique identification of the base station; establish an IP link with the network management system according to the IP address returned by the network management system; and load base station software and configuration data according to information acquired from the network management system.

In an exemplary embodiment, the operation that the self-recovery module loads base station software and configuration data according to information acquired from the network management system refers to that:

the self-recovery module sends a request for acquiring base station software and configuration data to the network management system; receives the base station software and configuration data returned by the network management system; and loads the base station software and configuration data.

In an exemplary embodiment, error information is further carried when the self-recovery module sends the request for acquiring the IP address to the network management system; and the operation that the self-recovery module loads base station software and configuration data according to information acquired from the network management system refers to that:

the self-recovery module receives a patch pack returned by the network management system, herein the patch pack includes correction information for base station software and configuration data; and reloads the base station software and configuration data according to the correction information.

A self-recovery device after disconnection of a base station includes:

a link interruption detection module, arranged in a base station and configured to, when the base station cannot connect with a network management system through a link, detect a link interruption cumulative time length;

a self-recovery module, arranged in the base station and configured to, when the link interruption cumulative time length detected by the link interruption detection module exceeds a designated time length, send a request for acquiring an IP address to the network management system through an underlying communication protocol, herein the request carries a unique identification of the base station; establish an IP link with the network management system according to the IP address returned by the network management system; and load base station software and configuration data according to information acquired from the network management system; and

a self-recovery service module, arranged in the network management system and configured to, when receiving the request for acquiring the IP address, search for the IP address corresponding to the unique identification in the request in base station information which is saved in advance, and return the searched IP address to the self-recovery module in the base station.

In an exemplary embodiment, the operation that the self-recovery module loads base station software and configuration data according to information acquired from the network management system refers to that:

the self-recovery module sends a request for acquiring base station software and configuration data to the network management system; receives the base station software and configuration data returned by the network management system; and loads the base station software and configuration data;

after receiving the request for acquiring base station software and configuration data, the self-recovery service module searches for the base station software and configuration data of the base station in the base station information which is saved in advance, and returns the searched base station software and configuration data to the self-recovery module in the base station.

In an exemplary embodiment, error information is further carried when the self-recovery module sends the request for acquiring the IP address to the network management system; and the operation that the self-recovery module loads base station software and configuration data according to information acquired from the network management system refers to that:

after the IP link is established, the self-recovery service module generates a patch pack according to the error information and return the patch pack to the base station, herein the patch pack includes correction information for base station software and configuration data; and

the self-recovery module receives the patch pack returned by the network management system; and reloads the base station software and configuration data according to the correction information.

A self-recovery method after disconnection of a base station, applied to a base station side, includes the following steps.

When a base station cannot connect with a network management system through a link, the base station detects a link interruption cumulative time length.

When the link interruption cumulative time length exceeds a designated time length, the base station sends a request for acquiring an IP address to the network management system through an underlying communication protocol, herein the request carries a unique identification of the base station.

The base station establishes an IP link with the network management system according to the IP address returned by the network management system.

The base station loads base station software and configuration data according to information acquired from the network management system.

In an exemplary embodiment, the step that the base station loads base station software and configuration data according to information acquired from the network management system includes:

the base station sends a request for acquiring base station software and configuration data to the network management system;

the base station receives the base station software and configuration data returned by the network management system; and

the base station loads the base station software and configuration data.

In an exemplary embodiment, the step that the base station sends the request for acquiring the IP address to the network management system through the bottom communication protocol includes: the base station carries error information in the request; and

the step that the base station loads base station software and configuration data according to information acquired from the network management system includes: the base station receives a patch pack returned by the network management system, herein the patch pack includes correction information for base station software and configuration data; and the base station reloads the base station software and configuration data according to the correction information.

A self-recovery method after disconnection of a base station, applied to a network management system side, includes the following steps.

The network management system receives a request for acquiring an IP address sent by a base station through an underlying communication protocol, herein the request carries a unique identification of the base station.

After receiving the request for acquiring the IP address, the network management system searches for the IP address corresponding to the unique identification in base station information which is saved in advance, and returns the searched IP address to the base station.

The network management system establishes an IP link with the base station according to the IP address.

The network management system sends base station software and configuration data for information loading to the base station according to the request of the base station.

In an exemplary embodiment, the step that the network management system sends base station software and configuration data for information loading to the base station according to the request of the base station includes:

the network management system receives a request for acquiring base station software and configuration data sent by the base station; and

the network management system searches for the base station software and configuration data of the base station in the base station information which is saved in advance, and returns the searched base station software and configuration data to the base station.

In an exemplary embodiment, the request for acquiring the IP address further carries error information; and the step that the network management system sends base station software and configuration data for information loading to the base station according to the request of the base station includes:

the network management system generates a patch pack according to the error information and returns the patch pack to the base station, herein the patch pack includes correction information for base station software and configuration data such that the base station reloads the base station software and configuration data according to the correction information.

A self-recovery device after disconnection of a base station, arranged in a base station, includes a link interruption detection module and a self-recovery module.

The link interruption detection module is configured to, when the base station cannot connect a network management system through a link, detect a link interruption cumulative time length.

The self-recovery module is configured to, when the link interruption cumulative time length detected by the link interruption detection module exceeds a designated time length, send a request for acquiring an IP address to the network management system through an underlying communication protocol, herein the request carries a unique identification of the base station; establish an IP link with the network management system according to the IP address returned by the network management system; and load base station software and configuration data according to information acquired from the network management system.

In an exemplary embodiment, the self-recovery module is configured to load base station software and configuration data according to information acquired from the network management system by the following mode:

the self-recovery module sends a request for acquiring base station software and configuration data to the network management system; further receives the base station software and configuration data returned by the network management system; and loads the base station software and configuration data.

In an exemplary embodiment, the request for acquiring the IP address sent by the self-recovery module to the network management system further carries error information; and

the self-recovery module is configured to load base station software and configuration data according to information acquired from the network management system by the following mode: the self-recovery module receives a patch pack returned by the network management system, herein the patch pack includes correction information for the base station software and configuration data; and reloads the base station software and configuration data according to the correction information.

A self-recovery device after disconnection of a base station, arranged at a network management system side, includes a self-recovery service module and a base station information table saving module.

The self-recovery service module is configured to, when receiving a request for acquiring an IP address sent by a base station through an underlying communication protocol, search for the IP address corresponding to a unique identification of the base station in the request in base station information which is saved in advance, and return the searched IP address to the base station; establish an IP link with the base station according to the IP address; and send base station software and configuration data for information loading to the base station according to the request of the base station.

The base station information table saving module is configured to save the IP address of the base station, the base station software and configuration data for information loading and a patch pack.

In an exemplary embodiment, the self-recovery service module is configured to send base station software and configuration data for information loading to the base station according to the request of the base station by the following mode:

the self-recovery service module receives a request for acquiring base station software and configuration data sent by the base station, then searches for the base station software and configuration data of the base station in the base station information which is saved in advance, and returns the searched base station software and configuration data to the base station.

In an exemplary embodiment, the request for acquiring the IP address further carries error information; and

the self-recovery service module is further configured to, after the IP link is established, generate a patch pack according to the error information and return the patch pack to the base station, herein the patch pack includes correction information for base station software and configuration data such that the base station reloads the base station software and configuration data according to the correction information.

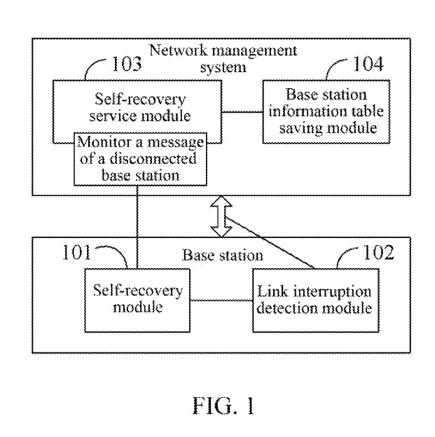

In one embodiment, a self-recovery device after disconnection of a base station, as illustrated in FIG. 1, includes a self-recovery module 101, a link interruption detection module 102, a self-recovery service module 103 and a base station information table saving module 104.

The self-recovery module 101 arranged at a base station side is configured to initiate a system recovery operation by the base station. After this function operates, the base station may establish a temporary communication channel with a network management system through an underlying communication protocol, to provide a recovery entrance, and may also acquire base station software and configuration data on the network management system.

The link interruption detection module 102 arranged at the base station side is configured to detect a situation of link interruption and an interruption time length.

The self-recovery service module 103 arranged at a network management system side is configured to provide a tool necessary for network element self-recovery, a correct software release of the network element and information such as configuration data; and further configured to provide a monitoring service for monitoring a request message of a disconnected base station (by adopting an underlying communication protocol). Through the cooperation between the self-recovery module at the base station side and the self-recovery service module at the network management side, the damaged base station system can be recovered to a normal working state.

The base station information table saving module 104 arranged at the network management system side is configured to record base station information, including a unique identification of the base station, an IP address of the base station, a correct software release of the base station, correct configuration data of the base station and the like.

At initialization and deployment stage:

The base station information table module 104 and the self-recovery service module 103 need to be deployed at the network management side. Herein, a base station information table records unique identifications of all network elements (usually mainboard Electronic Identifiers (EIDs) of base stations, i.e., electronic sequence numbers), IP addresses, software release information and configuration data information. The self-recovery service module further supports a service of monitoring a request message of a disconnected base station, and usually the self-recovery service module may be a DHCP server or other bottom communication protocol server. The self-recovery service module may call information in the base station information table.

The link interruption detection module 102 arranged at the base station side and the self-recovery module 101 arranged at the base station side need to be deployed at the base station side. The link interruption detection module is an underlying module, and is required to be capable of operating normally at any time and is not influenced by new base station software release and configuration data. The self-recovery module may acquire the IP address, the software release and the configuration data from the network management system.

In other embodiments, the base station information may also be saved in the self-recovery service module 103 in advance in forms of files, tables and the like, or be saved at other locations from which the information can be acquired.

In another embodiment, a system preparation process is as follows.

The base station information table module is used to configure basic information of the base station, including the unique identification of the base station, the IP address of the base station, the correct software release of the base station, the correct configuration data of the base station and the like.

The network management system starts the self-recovery service module to perform an operation including monitoring the request message of the disconnected base station.

The base station starts the link interruption detection module and the self-recovery module.

In this embodiment, a system operation process is as follows and includes steps 100-170.

In step 100, in an initial state, a base station and a network management system operate normally and communicate normally. Correction information of the base station, including a unique identification of the base station, an IP address of the base station, a correct software release of the base station, correct configuration data of the base station and the like, is stored in a base station information table at a network management system side. A link interruption detection module at a base station side also operates normally. At the moment, a user sends an incorrect software release or configuration data to the base station. After the base station software or configuration data takes effect, the base station cannot operate normally and the base station is disconnected.

In step 110, the link interruption detection module at the base station side is an underlying module, and normal operation of the link interruption detection module can be guaranteed, and when the link interruption detection module detects that a link between the base station and the network management system is interrupted over a designated time length, the link interruption detection module interrupts a current standard start process of the base station and triggers to start a self-recovery module at the base station side.

In step 120, the self-recovery module at the base station side initiates a broadcast message in a network, and the message requests for a correct IP address of the base station. The message belongs to an underlying communication protocol and does not rely on a normal communication link between the network management system and the base station. Therefore, even though the normal link is interrupted, the message may also be received and transmitted normally. The message includes the unique identification of the base station and some error information. The message may be received by the network management system. After the network management system receives the message, the self-recovery service module at the network management side searches for the base station information table, locates the IP address of the base station according to the unique identification of the base station and returns the IP address to the base station.

In step 130, after the base station acquires the correct IP address, the base station uses the IP address for setting and establishes an IP link (temporary communication link) with the network management system.

In step 140, after the link is connected, the network management system may firstly perform analysis according to the received error information to judge whether a correction solution can be automatically provided according to a corresponding relationship between preconfigured error information and correction solutions, e.g., providing and sending a patch pack of configuration data to the base station. If the network management system cannot perform correction by the above-mentioned process, the base station is notified to acquire complete base station software and configuration data.

In step 150, the base station sends a message to the network management system to request for acquiring the complete base station software and configuration data.

In step 160, the network management system searches the base station information table and returns the base station software and configuration data to the base station.

In step 170, after the base station downloads the correct base station software and configuration data, the base station loads and operates the correct base station software and configuration data, and the base station normally communicates with the network management system. At this moment, maintenance personnel can perform various maintenance operations on the base station by using the network management system.

When the base station operates normally, since the link interruption detection module at the base station side detects that the link is normal, the above-mentioned process will not be triggered. When the link is interrupted due to failure of the transmission link, although the base station side will trigger a self-recovery request, since the transmission link is blocked, the base station cannot acquire the correct IP address and the process will be not continuously executed. Once transmission becomes normal, the link interruption detection module at the base station side will detect that the link is normal and the base station self-recovery process will be not triggered. At the moment, if the self-recovery process has already been started, the self-recovery process may also be terminated. Therefore, the above-mentioned self-recovery process is triggered only under a situation that the transmission link is normal and the link cannot be established since the base station software or configuration data is incorrect.

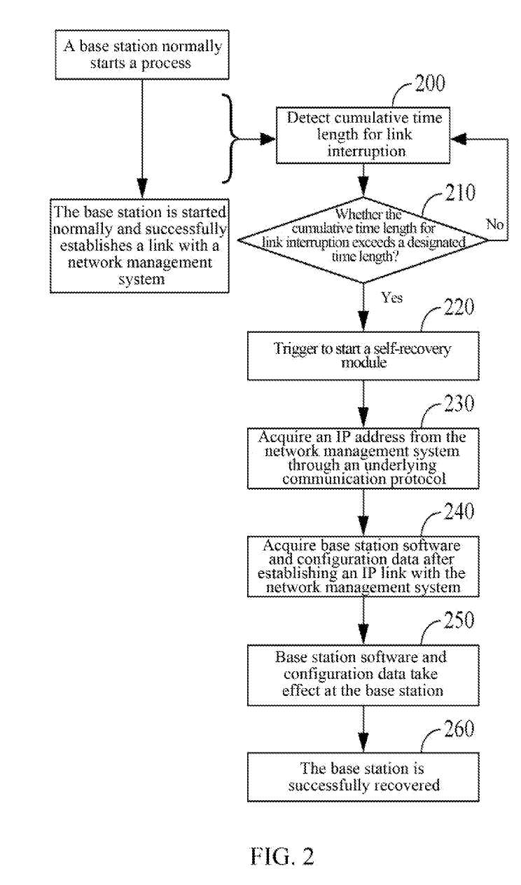

In another embodiment, an operation process at a base station side, as illustrated in FIG. 2, includes steps 200-260.

In step 200, in a period from a moment that a base station normally starts a process to a moment that the base station is normally started and successfully establishes a link with a network management system, a link interruption detection module detects a link interruption cumulative time length.

In step 210, if the link interruption cumulative time length exceeds a designated time length, step 220 is executed, and otherwise detection is continuously performed.

In step 220, a self-recovery module is triggered to be stated.

In step 230, the self-recovery module acquires an IP address from the network management system through an underlying communication protocol.

In step 240, after the self-recovery module establishes an IP link with the network management system, the self-recovery module acquires base station software and configuration data.

In step 250, the base station software and configuration data take effect at the base station.

In step 260, the base station is successfully recovered.

Herein, steps 220-260 belong to the self-recovery process. If the base station is successfully started after the base station is disconnected due to transmission failure, the self-recovery process will be interrupted. Detail description will be made below in combination with two embodiments.

### Embodiment One

At a base station side, a process includes the following steps S11-S15.

In step S11, a base station starts a normal start process and a base station information table is filled with complete information.

In step S12, since base station software or configuration data is abnormal, the base station cannot enter a normal start state and cannot successfully establish a link with a network management system.

In step S13, a link interruption detection module detects that a link interruption cumulative time length exceeds a designated time length, a self-recovery module of the base station is triggered.

In step S14, the self-recovery module sends a request for acquiring an IP address to the network management system through an underlying communication protocol, herein the request carries a unique identification of the base station; and after the IP address is successfully acquired, the self-recovery module continues to send a request for acquiring base station software and configuration data to the network management system.

In step S15, after all information is successfully acquired, the base station is recovered to be normal.

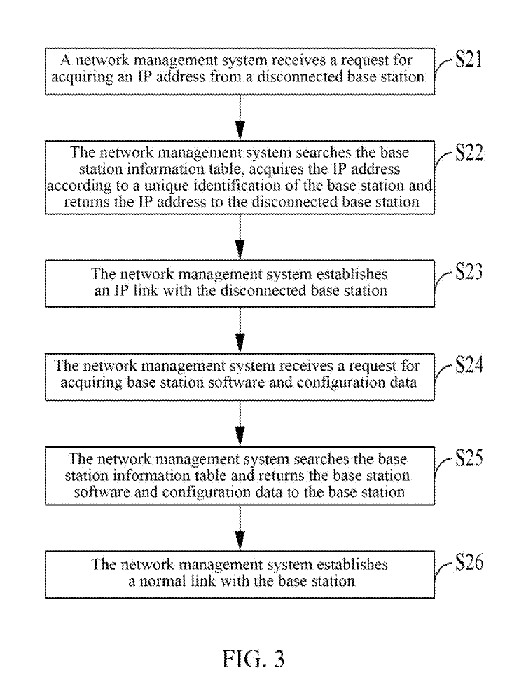

At a network management system side, as illustrated in FIG. 3, a process includes the following steps S21-26.

In step S21, the network management system receives a request for acquiring an IP address from a disconnected base station, herein the request carries a unique identification of the disconnected base station.

In step S22, the network management system searches the base station information table, acquires the corresponding IP address according to the unique identification of the disconnected base station and returns the IP address to the disconnected base station.

In step S23, the network management system establishes an IP link with the disconnected base station.

In step S24, the network management system receives a request for acquiring base station software and configuration data from the disconnected base station.

In step S25, the network management system sends corresponding base station software and configuration data to the disconnected base station according to the base station information table.

In step S26, the network management system establishes a normal maintenance link with the disconnected base station.

### Embodiment Two

At a base station side, a process includes the following steps S31-S35.

In step S31, a base station starts a normal start process and a base station information table is filled with complete information.

In step S32, since base station software or configuration data is abnormal, the base station cannot enter a normal start state and cannot successfully establish a link with a network management system.

In step S33, a link interruption detection module detects that a link interruption cumulative time length exceeds a designated time length, a self-recovery module of the base station is triggered.

In step S34, the self-recovery module sends a request for acquiring an IP address to the network management system through an underlying communication protocol, herein the request carries a unique identification of the base station and error information; and after the IP address is successfully acquired, the self-recovery module receives a patch pack sent by the network management system.

In step S35, after the loading succeeds according to the patch pack, the base station is recovered to be normal.

At a network management system side, a process includes the following steps S41-S45.

In step S41, the network management system receives a request for acquiring an IP address from a disconnected base station, herein the request carries a unique identification of the base station and error information.

In step S42, the network management system searches the base station information table, acquires the corresponding IP address according to the unique identification of the disconnected base station and returns the IP address to the disconnected base station.

In step S43, the network management system establishes an IP link with the disconnected base station.

In step S44, the network management system analyzes the error information of the disconnected base station, performs self-diagnosis, provides a patch pack for correcting base station software and configuration data, and sends the patch pack to the disconnected base station, herein the patch pack includes correction information for base station software and configuration data.

In step S45, after the disconnected base station receives the patch pack, the disconnected base station loads the corresponding base station software and configuration data according to the correction information and is started successfully, and then establishes a normal maintenance link with the network management system.

Another embodiment of the present disclosure further discloses a computer program, including program instructions. When the program instructions are executed by a base station, the base station can execute the self-recovery method after disconnection of the base station applied to the base station side.

Still another embodiment of the present disclosure further discloses a carrier carrying the computer program.

Another embodiment of the present disclosure further discloses a computer program, including program instructions. When the program instructions are executed by a network management system, the network management system can execute the self-recovery method after disconnection of the base station applied to the network management system side.

Still another embodiment of the present disclosure further discloses a carrier carrying the computer program.

Of course, the present disclosure may have other various embodiments. One skilled in the art may make various corresponding modifications and variations according to the present disclosure without departing from the rule and essence of the present disclosure. However, such corresponding modifications and variations should be all included in the protection scope of the claims of the present disclosure.

### INDUSTRIAL APPLICABILITY

Aiming at the problem that a great amount of labor and time are wasted and consumed since personnel have to go to a base station for recovery at present when disconnection of the base station is caused and the base station cannot communicate with a network management system due to incorrectly issuing of base station software or configuration data in related base station management, the present disclosure provides a new solution. By using the technical solution provided by the present disclosure, the system can automatically solve the problem of disconnection of the base station which is caused when the base station software or configuration data is abnormal. In the existing art, personnel need to go to the base station, and consequently a great amount of labor and time are consumed. By using the technical solution provided by the present disclosure, the problem is avoided and the system availability is improved. Therefore, the present disclosure has very strong industrial applicability.

1. A self-recovery method after disconnection of a base station, applied to a base station side, comprising:
when a base station cannot connect with a network management system through a link, the base station detecting a cumulative time length for link interruption;
when the cumulative time length for link interruption exceeds a designated time length, the base station sending a request for acquiring an Internet Protocol, IP, address to the network management system through an underlying communication protocol, wherein the request carries a unique identification of the base station;
the base station establishing an IP link with the network management system according to the IP address returned by the network management system; and
the base station loading base station software and configuration data according to information acquired from the network management system.

2. The self-recovery method after disconnection of the base station according to claim 1, wherein the step of the base station loading base station software and configuration data according to information acquired from the network management system comprises:
the base station sending a request for acquiring the base station software and configuration data to the network management system;
the base station receiving the base station software and configuration data returned by the network management system; and
the base station loading the base station software and configuration data.

3. The self-recovery method after disconnection of the base station according to claim 1, wherein,
the step of the base station sending a request for acquiring an IP address to the network management system through an underlying communication protocol comprises: the base station carrying error information in the request; and
the step of the base station loading base station software and configuration data according to information acquired from the network management system comprises: the base station receiving a patch pack returned by the network management system, wherein the patch pack comprises correction information for base station software and configuration data; and the base station reloading the base station software and configuration data according to the correction information.

4. A self-recovery method after disconnection of a base station, applied to a network management system side, comprising:
the network management system receiving a request for acquiring an Internet Protocol, IP, address sent by a base station through an underlying communication protocol, wherein the request carries a unique identification of the base station;
after receiving the request for acquiring the IP address, the network management system searching for the IP address corresponding to the unique identification in base station information which is saved in advance, and returning the searched IP address to the base station;
the network management system establishing an IP link with the base station according to the IP address; and
the network management system sending base station software and configuration data for information loading to the base station according to the request of the base station.

5. The self-recovery method after disconnection of the base station according to claim 4, wherein the step of the network management system sending base station software and configuration data for information loading to the base station according to the request of the base station comprises:
the network management system receiving a request for acquiring the base station software and configuration data sent by the base station; and
the network management system searching for the base station software and configuration data of the base station in the base station information which is saved in advance, and returning the searched base station software and configuration data to the base station.

6. The self-recovery method after disconnection of the base station according to claim 4, wherein:
the request for acquiring the IP address further carries error information; and
the step of the network management system sending base station software and configuration data for information loading to the base station according to the request of the base station comprises:
the network management system generating a patch pack according to the error information and returning the patch pack to the base station, wherein the patch pack comprises correction information for base station software and configuration data such that the base station reloads the base station software and configuration data according to the correction information.

7. A self-recovery device after disconnection of a base station, arranged in a base station, comprising a link interruption detection module and a self-recovery module, wherein:
the link interruption detection module is configured to, when the base station cannot connect with a network management system through a link, detect a cumulative time length for link interruption; and
the self-recovery module is configured to, when the cumulative time length for link interruption detected by the link interruption detection module exceeds a designated time length, send a request for acquiring an Internet Protocol, IP, address to the network management system through an underlying communication protocol, wherein the request carries a unique identification of the base station; establish an IP link with the network management system according to the IP address returned by the network management system; and load base station software and configuration data according to information acquired from the network management system.

8. The self-recovery device after disconnection of the base station according to claim 7, wherein the self-recovery module is configured to load base station software and configuration data according to information acquired from the network management system by the following mode:
the self-recovery module sending a request for acquiring the base station software and configuration data to the network management system; receiving the base station software and configuration data returned by the network management system; and loading the base station software and configuration data.

9. The self-recovery device after disconnection of the base station according to claim 7, wherein:
the request for acquiring the IP address sent by the self-recovery module to the network management system further carries error information; and
the self-recovery module is configured to load base station software and configuration data according to information acquired from the network management system by the following mode: the self-recovery module receiving a patch pack returned by the network management system, wherein the patch pack comprises correction information for the base station software and configuration data; and reloading the base station software and configuration data according to the correction information.

10. A self-recovery device after disconnection of a base station, arranged at a network management system side, comprising a self-recovery service module and a base station information table saving module, wherein:
the self-recovery service module is configured to, when receiving a request for acquiring an Internet Protocol, IP, address sent by a base station through an underlying communication protocol, search for the IP address, corresponding to a unique identification of the base station in the request, in base station information which is saved in advance, and return the searched IP address to the base station; establish an IP link with the base station according to the IP address; and send base station software and configuration data for information loading to the base station according to the request of the base station; and
the base station information table saving module is configured to save the IP address of the base station, the base station software and configuration data for information loading and a patch pack.

11. The self-recovery device after disconnection of the base station according to claim 10, wherein the self-recovery service module is configured to send base station software and configuration data for information loading to the base station according to the request of the base station by the following mode:
the self-recovery service module receiving a request for acquiring base station software and configuration data sent by the base station, and then searching for the base station software and configuration data of the base station in the base station information which is saved in advance, and returning the searched base station software and configuration data to the base station.

12. The self-recovery device after disconnection of the base station according to claim 10, wherein:
the request for acquiring the IP address further carries error information; and
the self-recovery service module is further configured to, after the IP link is established, generate a patch pack according to the error information and return the patch pack to the base station, wherein the patch pack comprises correction information for the base station software and configuration data such that the base station reloads the base station software and configuration data according to the correction information.

13. A computer program, comprising program instructions, wherein when the program instructions are executed by a base station, the base station can execute the self-recovery method after disconnection of the base station according to claim 1.

14. A carrier carrying the computer program according to claim 13.

15. A computer program, comprising program instructions, wherein when the program instructions are executed by a network management system, the network management system can execute the self-recovery method after disconnection of the base station according to claim 4.

16. A carrier carrying the computer program according to claim 15.

17. A computer program, comprising program instructions, wherein when the program instructions are executed by a base station, the base station can execute the self-recovery method after disconnection of the base station according to claim 2.

18. A computer program, comprising program instructions, wherein when the program instructions are executed by a base station, the base station can execute the self-recovery method after disconnection of the base station according to claim 3.

19. A computer program, comprising program instructions, wherein when the program instructions are executed by a network management system, the network management system can execute the self-recovery method after disconnection of the base station according to claim 5.

20. A computer program, comprising program instructions, wherein when the program instructions are executed by a network management system, the network management system can execute the self-recovery method after disconnection of the base station according to claim 6.
